(19) United States
(12) Patent Application Publication
(10) Pub. No.: US 2002/0107035 A1
(43) Pub. Date: Aug. 8, 2002

(54) Radiolocalization system specially for terrestrial mobile telephony

(76) Inventor: Gines Sanchez Gomez, Mostoles (ES)

Correspondence Address: GINES SANCHEZ GOMEZ, CALLE CERVANTES, 1, 7, B, 28.932 - MOSTOLES (MADRID), ES

(21) Appl. No.: 10/062,074

(22) Filed: Jan. 28, 2002

(30) Foreign Application Priority Data
Feb. 6, 2001 (ES) P200100290

(51) Int. Cl. H04Q 7/20

(52) U.S. Cl. 455/456; 455/457

(57) ABSTRACT

A, B, and C are three radio-stations of known position and X a radio-station of unknown position, X emits continually a sign composed by an emission identifier IE and a number N, obtained from a counter controlled by a clock of pulses, A receives and repeats continually the sign, the repeated sign is received by X, by comparing received N with counter in moment of reception, distance between A and X is obtained; measures of X to C and D allow calculate its position.

### CROSS-REFERENCE TO RELATED APPLICATIONS

Current invention is derived from Spanish patent application P200100290, dated Feb. 6, 2001, which is priority.

U.S. Pat. Nos. 5,208,756 dated May 4, 1993, WO9205672 dated Apr. 2, 1992 and 5,666,662 dated Sep. 09, 1997 are related.

U.S. Pat. No. 5,208,756. A mobile obtains its position by distances to three radio-stations, each radio-stations with known position. The distance to each radio-station is obtained solving the equation of waves propagation. The mobile position is calculated by arculation or triangulation.

WO9205672. It is closely linked GSM system. A mobile obtains its position by emitting a radio-localization sign. Sign is received by three radio-stations, each radio-station retransmits sign together with measures of function TA of system GPS to a calculation center, and calculation center retransmits calculated position to a presentation console. The mobile position is obtained by common point of instersección of three circles, each circle defined by each radio-station position and its distance to mobile.

U.S. Pat. No. 5,666,662. It is similar previous WO9205672, but it looks as guided to the North American radio-phone system.

### BACKGROUND OF THE INVENTION

As mentioned patents, this invention obtains mobile position by distances to three radio-stations, each radio-stations with known position, but distances are calculated by measuring time difference between a sign emitted by mobile and same sign received after be repeated by a fixed radio station.

The mobile estimates its position by calculating the center of the tangent circle of smaller radius to the three circles defined by geographical position of three fixed radio- stations and their distances to mobile.

### BRIEF SUMMARY OF THE INVENTION

A mobile X to know its position, emits a sign of frequency fX, which contains a digital sequence with following information:

emission identification (IE), this IE is a binary sequence, being a key so that the receivers recognize a sign like a radio-localization sign.

a binary number (N) obtained from a counter activated by a clock of pulses, being Dbt the interval between pulses. It represents the moment in that the sign is emitted.

A station A of known position “collaborates” to obtain the position of X by receiving the sign of X, demodulating it, modulating it in a different frequency and forwarding it.

The “reflected” sign is received by X that has a receiver for it.

A microprocessor located in X calculates distance X-A-X comparing value of field N of reflected wave with the counter value at moment of reception of the sign, multiplying by Dbt and by speed of propagation of the sign, and subtracting times of retard of the processes. Retard times are constant because each process is repetitive. Half of the distance X-A-X it is the distance X-A.

Obtaining X other two distances to other two radio-stations B and C, the microprocessor estimates position of mobile by calculating center of tangent circle of smaller radius to three circles defined by centers A, B and C and radiuses X-A, X-B and X-C.

An estimation of error is the radius of tangent circle.

### BRIEF DESCRIPTION OF THE FIGURES

FIG. 1. General scheme of operation of system.

FIG. 2. Emission scheme of initial sign by mobile.

FIG. 3. Formation circuit of initial sign.

FIG. 4. Repetition process of initial sign by fixed radio-stations.

FIG. 5. Repeater circuit in fixed radio-stations.

FIG. 6. Identifier circuit of localization sign.

FIG. 7. Basic comparator circuit.

FIG. 8. Reception process of repeated sign.

FIG. 9. Data captator circuit.

FIG. 10. Bit's captator circuits.

Reference of symbol of a figure different to main figure in each section has the format (x.y), x: figure number, y: symbol number into each figure.

Representation of logical doors are following:

AND: triangle with several entrances and one exit,

OR: semicircle with several entrances and one exit,

NOT: triangle with one entrance and one exit,

FLIP-FLOP: rectangle with the letters BT, with one entrance and one exit. They are flip-flop JK, mode T.

### DETAILED DESCRIPTION OF THE INVENTION AND FIGURES

To IE and N fields seen in BRIEF SUMMARY OF THE INVENTION, I add the following:

IT mobile identification, be. their phone number if mobile is a radio-telephone,

IC a field with enough longitude to contain geographical coordinates of a point,

IR field to pick up the operation retards.

General scheme of operation of system

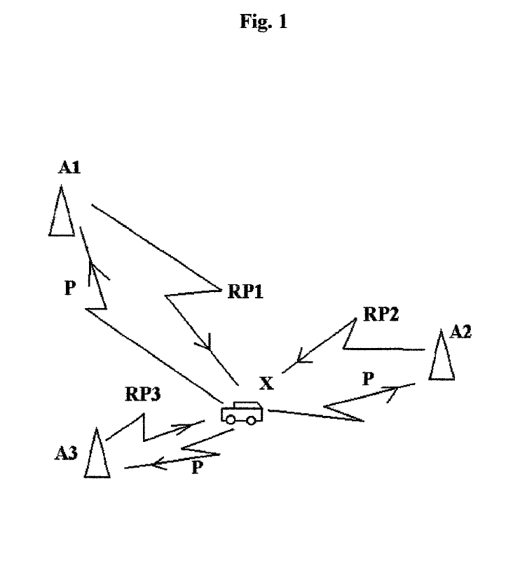

It is schematized in FIG. 1.

The mobile (X) to know its position selects an available frequency and emits repetitively the sign (P) formed by fields IE, IT, N, IC, IR. Last two fields are initially emitted in blank.

The fixed radio stations (A1, A2 and A3) receive emission from X they insert their geographical coordinates in IC, and they put in IR value of their operation retards (in Dbt units), reemitting continually in free frequencies (RP1, RP2, RP3). Field IR is the number of Dbt of retard of operation of demodulation, detection, insertion of IC and IR, reemission, . . . .

A receiver located in the mobile scans all frequencies of working band, by selecting frequencies containing information with format IE, IT, N, IC, IR, with its own IT, until that mobile obtains three waves of different repeaters. Having in account the retard of operation of the mobile, distances (X)-A1)(X)-(A2) and (X)-(A3) are obtained. With distances and geographical coordinates of (A1), (A2) and (A3) it is possible to estimate mobile position.

The above-mentioned is materialized according to following system.

Emission scheme of initial sign by mobile.

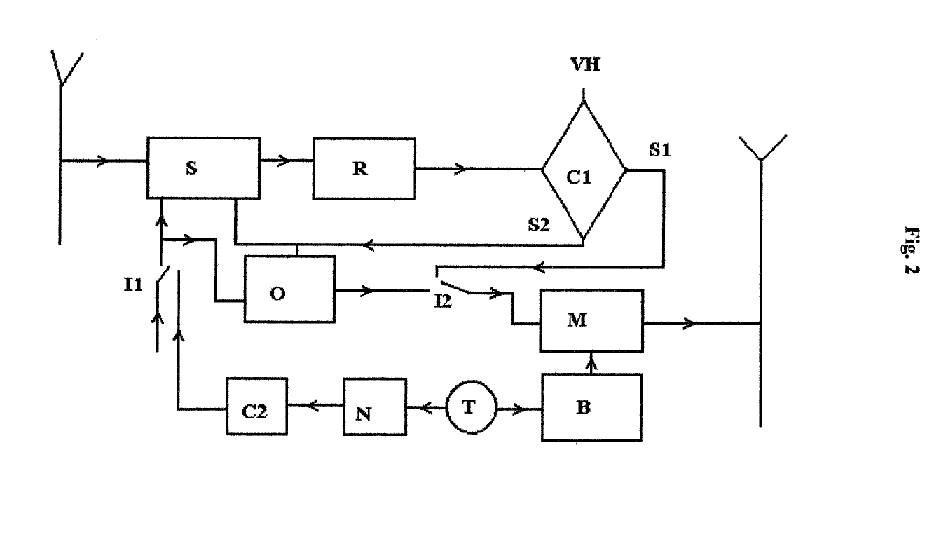

It is schematized in FIG. 2.

A switch is activated (I1), energizing all the radio-localization circuits. By clarity, only connections to tuner (S) and to oscillator (O) have been represented.

Oscillator (O) and tuner (S) are automatic, and they are synchronized so that both search/oscillate in the same frequency. Tuner (S) begins searching for a free frequency, tuner (S) scans its band of frequencies until finding a frequency without sign or with very weak sign. This is made with a rectifier (R) followed by a comparator (C1) with a threshold voltage (VH), above this threshold, it is considered that the frequency is busy, sending a pulse to tuner (S) and oscillator (O), so they goes successive frequency. On other hand, if sign coming from rectifier (R) is inferior to threshold voltage, it is a free frequency (S1, energizing the switch (I2) (be. a door AND), that connects oscillator (O) with modulation and codification circuit (M).

Modulation and codification circuit (M) modulates initial sign coming from generator (B), and modulation and codification circuit (M) begins emitting in the frequency of oscillator (O) fields IE, IT, N, IC and IR (IC and IR in blank).

Formation circuit of initial sign (B) receives impulses of Dbt period from a clock (T).

To avoid excessive times of occupation of frequencies, clock (T) feeds a counter (N). When the counter reaches certain value, comparator (C2) is actuated, by turning off the radio-localization system, by acting on the switch (I1).

Emission is interrupted when the mobile obtains its localization, by means of a sign from the calculation microprocessor to the switch (I1).

Formation circuit of initial sign.

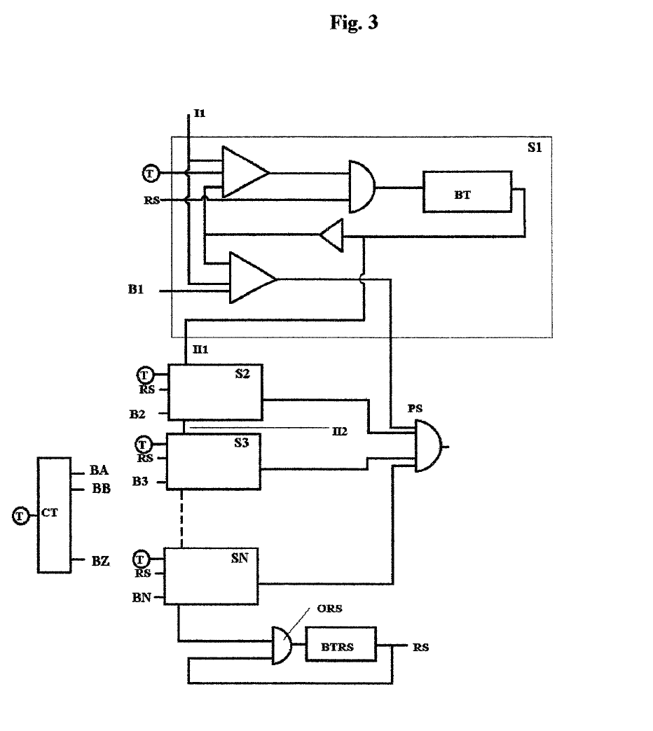

It is schematized in FIG. 3.

This circuit is basically a sequencer that produces the sequence of bits of fields IE, IT, N, IC, IR, from a representation in parallel.

Being nIE, nIR, nN, NICE and nIR the number of bits of each field, the number of sequencers is nIE+nIT+nN+nIC+nIR (S1, S2, S3, . . . , SN). All sequencers are identical, being represented the first sequencer (S1) more detailed.

Parallel bits are following:

B1 to B(nIE) represent IE

B(nIE+1) to B(nIE+nIT) represent IT

B(nIE+nIT+1) to B(nIE+nIT+nN) represent N

B(nIE+nIT+nN+1) to B(nIE+nIT nN+nIC) represent IC

B(nIE+nIT+nN+nIC+1) to B(nIE+nIT+nN+nIC+nIR) represent IR IE and IT bits are constants, IC and IR bits are constants value 0, and bits N are generated by counter (CT).

Sign (T), from system clock, activates counter (CT) and all sequencers (Bi).

Each sequencer contains a flip-flop (BT) and logical doors.

Each bit (Bi) goes through its sequencer (Si) to mixture door (PS) (OR type), when sequencer (Si) receives their sequence, during Dbt seconds.

The sequence goes from a sequencer to another by flip-flops (BT). First sequence sign is from switch (I1), and last sequence sign produces an initialization sign (RS) to begin process again.

Repetition process of initial sign by fixed stations.

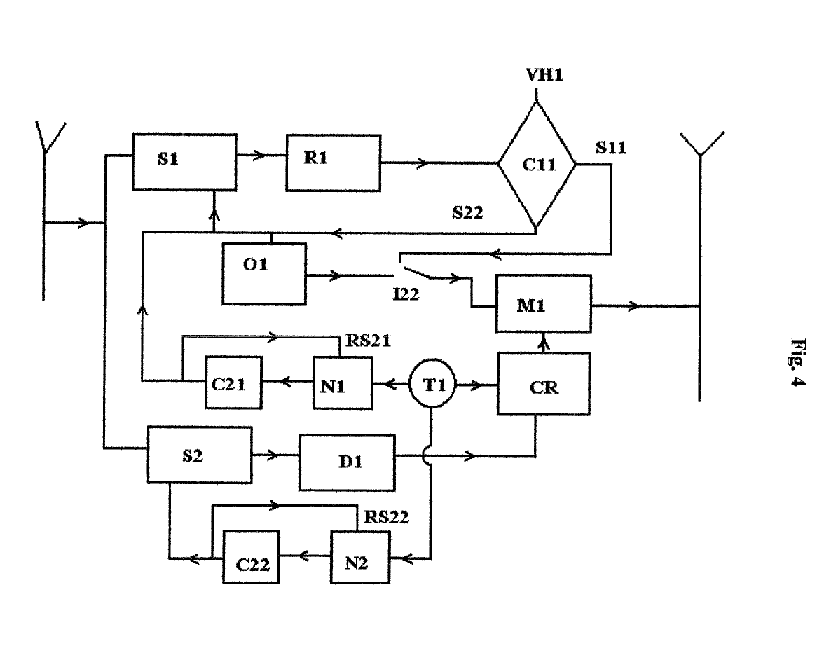

It is schematized in FIG. 4.

The radio stations (A1, A2 and A3) (FIG. 1) receive and reemit all signs that have a known IE, in a continuous way.

A received sign is transmitted to repeater circuit (CR) through a automatic tuner (S2) and a demodulator (D1). Tuner is controlled by an counter (N2) and a comparator (C22). Counter increases its value to impulses of clock of pulses (T1). A new sign is searched when counter has reached the maximum value. This maximum value is the necessary to detect field IE, being (nIE+nIT+nN+nIC+nIR)*2. When that value is reached, counter (N2) is initialized by sign (RS22).

The repeater circuit (CR) is controlled by clock of pulses (T1), which receives the demodulated sign, it checks that IE field is correct, in this case it stuffs continually IC and IR fields.

Sign of repeater circuit (CR) is emitted similarly to the sign produced by the device B of FIG. 2. In this way way, the signs M1, C21, . . . of FIG. 4 have same meaning that symbols M, C2, . . . of the FIG. 2. In FIG. 4 are not switch I1 because fixed radio-station works without interruption. The initiation sign RS21 makes that emitter changes frequency to intervals of preset bits.

Repeater circuit in fixed radio-stations.

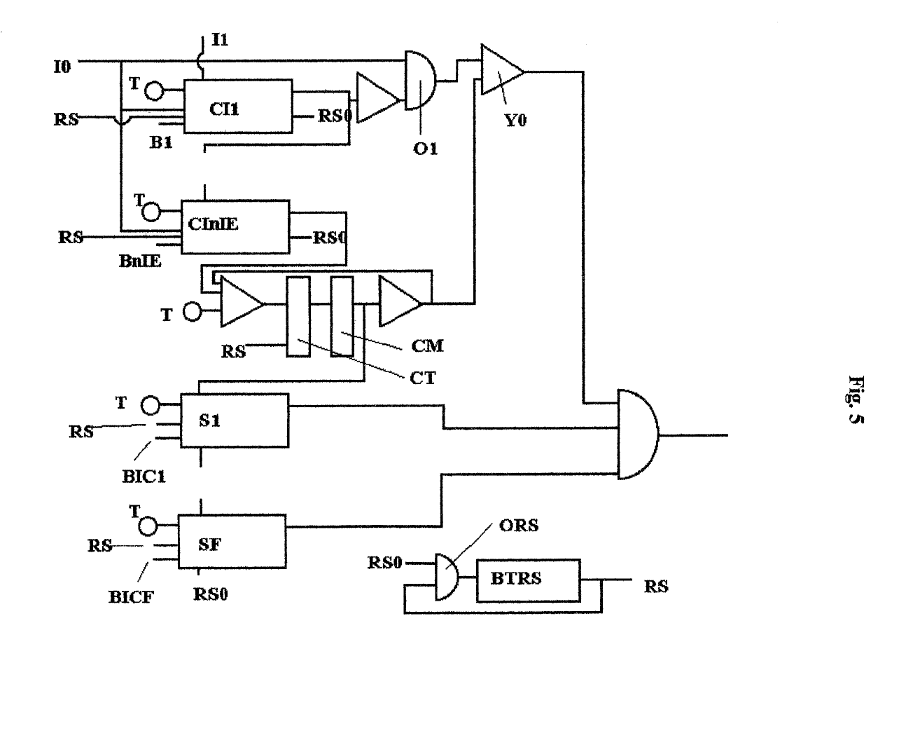

It is schematized in FIG. 5.

Repeater circuit has nIE identifier circuits (CI1, CI2, . . . , CInIE), a counter (CT) that counts until nIT+nN bits, a bit to bit comparator (CM), and nIC+nIR sequencers (S1, S2, . . . , SF; F=nIC+nIR).

Clock sign (T), from the clock T1 of the FIG. n° 4, it acts on CI1, . . . , CInIE, CT, S1, . . . , SF.

Counter (CT) is initialized with the common initialization sign (RS) and it is activated if IE sequence is identified. It allows that bits IT and N of I0 go directly to the repeater's exit.

Comparator (CM) is a serie of parallel circuits with each bit of counter (CT). Exit of all these circuits feeds a door AND (not represented).

The sequencers are identical to sequencers of “formation circuit of initial sign”, but applied to bits of IC and RC fields (BIC1, . . . ,BICF).

Operation is as following: sign (I0), already demodulated, feeds to all identifier circuits. Each identifier circuit receives sign (I0) if validation of previous circuit is positive. In another case the initialization sign RS0 is activated, by initializing all repeater circuits. When validation sign arrives to counter (CT), this counter begins to be increased, allowing the re-transmission of the initial sign until arriving to the IT field. When the counter arrives maximum value (nIT+nN), the initial sign is stopped by effect of comparador (CM) on door (Y0), and the bits of IC and IR fields begin to be inserted similarly to “formation circuit of initial sign”. At the end, the circuit is initialized by means of the sign (RS0).

The initialization signs (RS0) are transmitted through door OR (ORS) and flip-flop (BTRS), to become a signs of pulses.

Identifier circuit.

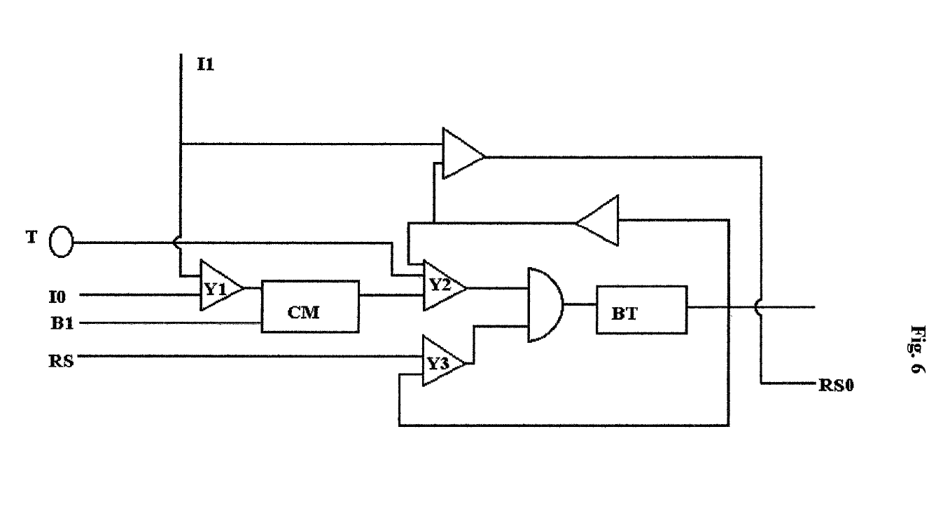

It is schematized in FIG. 6.

It consists of following inputs: activation sign (I1), time (T), sign to identify (10), initialization (RS), and comparison bit (B1). Exit is a validation sign that activates following identifier circuit if positive; or the initialization sign (RS0) if identification is negative.

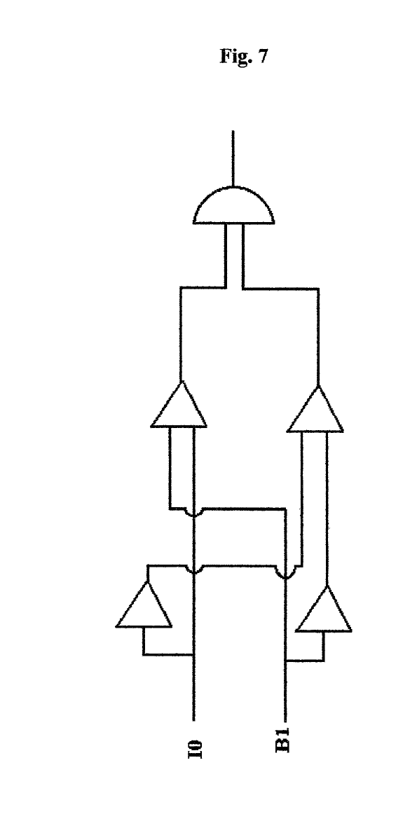

Identifier circuit has a basic comparator circuit (CM), eschematized in FIG. 7, and habitual flip-flop of sequence (BT).

Reception process of repeated sign.

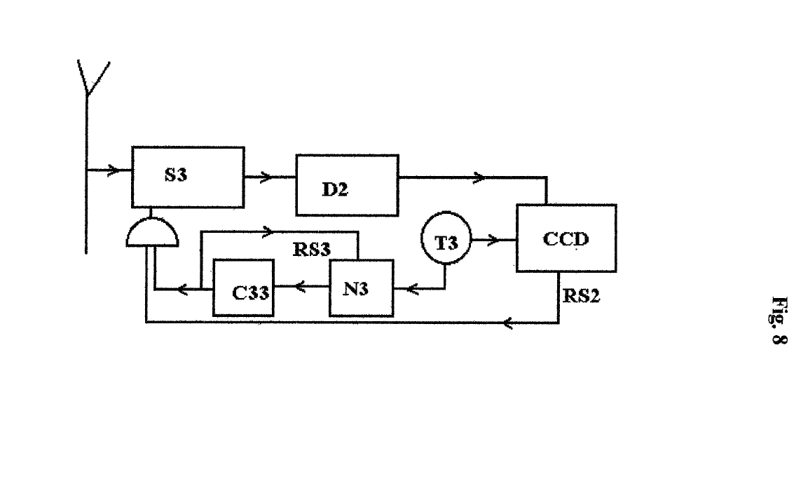

It is schematized in FIG. 8

Sign is transmitted to a data captator circuit (CCD) through an automatic tuner (S3) and a demodulator (D2). Automatic tuner is controlled by sign (RS2) from the “data captator circuit” (CCD), and by a counter (N3) and a comparator (C33). Counter increases its value by impulses of clock (T3), different of clock (T) of FIG. 2 (from here it is derived minimum error of Dbt seconds). Maximum value of counter is (nIE+nIT+nN+nIC+nIR)*3.

Data captator circuit.

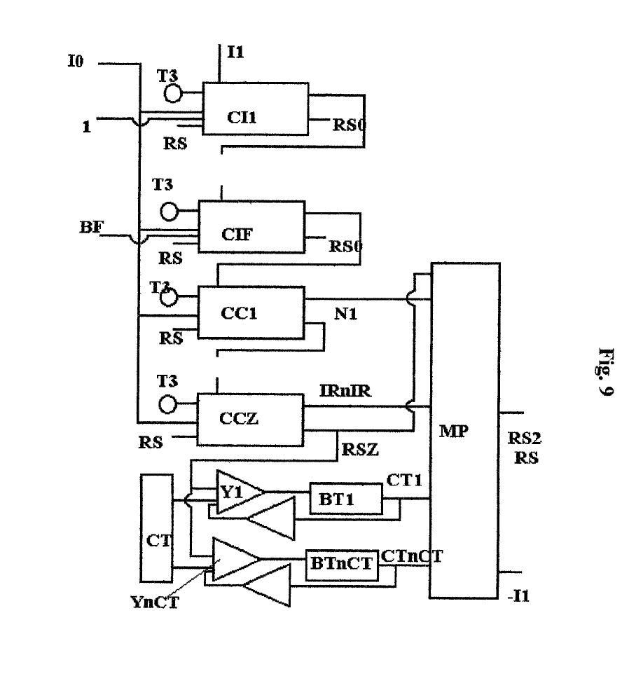

It is schematized in FIG. 9.

It consists of following devices:

nIE+nIT identifier circuits (FIG. 6) CI1. . . . , CIF that identify if it is a reflected wave initially coming from the mobile,

nN+nIC+nIR bit's captator circuits (CC1, . . . ,CC2). The exit of each bit's captator circuits is a bit of N, IC and IR fields in parallel,

counter (CT) (the same that counter of “formation circuit of initial sign”, FIG. 3),

doors (Y1, . . . ,YnCT),

flip-flops (BT1, . . . BTnCT) with the output signals (CT1, . . . , CTnCT), that mean the counter value in moment of reception of reflected wave,

microprocessor (MP) that is fed with the signs N1, . . . , IR , CT1, . . . , CTnCT, calculating distance with this signs, and generating the signs (RS2) (coincident with that of FIG. 8) to change the reception frequency, (RS) to initialize the data captator circuit, and (−I1) for deactivation of system,

time sign (T3), coming from clock 8.T3, acting on identifier circuits and bit's captator circuits,

initialization sign RS and sequence signs.

Last sign of sequence of last bit's captator circuits acts on doors Y1, . . . , YnCT to fix the counter's value in flip-flops BT1, . . . BTnCT, and on microprocessor MP to indicate that it has a set of data.

Bit's captator circuit.

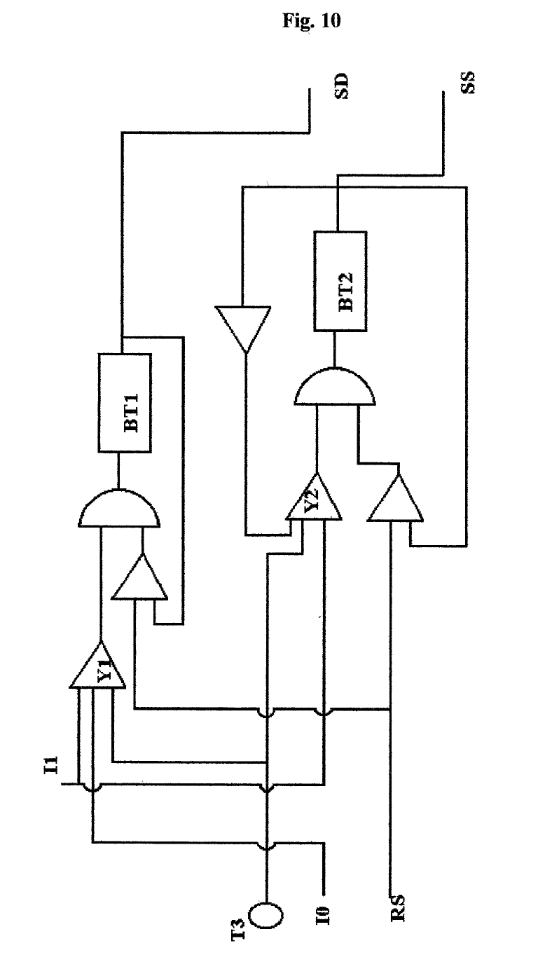

It is schematized in FIG. 10.

It consists of two internal circuits, both with the same input signals: time (T3), repeated sign (10), initialization (RS) and sequence (I1):

supporter circuit of the sign: it is formed by door (Y1) and flip-flop (BT1). Exit (SD) is the bit of sign (10) in the moment of the sampling,

sequence circuit: formed by door (Y2) and flip-flop (BT2).

Calculation and presentation of results.

When microprocessor mobile has three data sets, each one from different fixed radio station ( different IC field), it calculates distance to each fixed radio station and it emits sign—I1 (FIG. 9) to disable the system.

Being NN the value obtained from counter CT FIG. 9, NNM is maximum value of this counter, and RX the process time in mobile radio-station (X), distance is:

NN>=N

(A1−X)=(NNM+N−NN−IR−IRX)*Dbt*light speed/2−NN<N

(A1−X)=(N−NN−IR−IRX)*Dbt*light speed/2

Mobile (X) is near a circle radius (A1−X) and center (A1).

Identical considerations by regarding other fixed radio-stations (A2, A3).

A good estimation of mobile position (X) is the circle of smaller radius tangent to three described circles, being this last radius a good error estimation.

Once calculated mobile position, microprocessor can show result in a screen of mobile or remit the result to a preprogramed destination, via a message.

Avoiding multiple repetitions. In order to a fixed radio-station avoids repeated sign from another fixed radio-station, if the first bit of IE of initial sign begins with 1/O, the repeater circuit of each fixed radio-station should change this first bit to 0/1, and first bit's captator circuit mobile should identify bit 0/1.

For previous function, in circuit of FIG. 5 has been installed door OR (O1), which makes that IE of reflected sign begins with 1, being 0 inital first bit of IE, and IE detected by the data captator circuit should begin with 1.

Billing of service.

If IT is the telephonic mobile number, by inserting in the circuit of FIG. 5 bit's captator circuits after identifier circuits, IT can be transmitted to a computer to bill service.

Also microprocessor can bill against the mobile telephone card. In this case by last value of counter CT of FIG. 9.

### OTHER EMBODIMENTS OF THE INVENTION

The fixed radio stations emit and reflect initial sign. So a better carriers control is obtained.

Fixed radio stations when they emit initial signs they figure as field IE their own geographical position and they have emission and formation of initial sign circuits, and receiver and repeater circuit as pointed in “DETAILLED DESCRIPTION OF THE INVENTION”.

The mobile only has circuits of modified sign receiver, data captator circuit, and microprocessor for calculation and presentation of results, with the following modifications:

counter (9. CT) is independent of (3.CT),

bits for discrimination of the sign are only the last nIE−1 of field IE (the first bit, that identifies if sign is direct or reflected is omitted, because it receives both signs),

bits of IT field are bits to receive, they will be treated by microprocessor.

The microprocessor will receive data sets in the following format:

geographical position, blank, counter-emission, blank, counter-reception (direct emission from a fixed radio-station),

geographical position, geographical position, counter-emission, repetition process bits, counter-reception (reflected emission from a fixed radio-station).

The first sign arrived to (X) from (A1) and it is direct, and its reflected sign has been received from (A2).

Direct sign has traveled distance (A1−X), reflected sign has traveled distance (A1−A2−X), being known distance (A1−A2).

By difference between N and NN fields of reflected and direct signs, and having in account IR and IRX fields, the difference of distances (A1−X)−(A2−X) is obtained. This means the following: point (X) is near an ellipse of focuses (A1) and (A2), and with difference between semi-axes of (A1−X)−(A2−X). These elements define an ellipse.

With two measures set as mentioned, it is three ellipses. Center of tangent circle of minimum radius to the three ellipses, it is a good estimate of X position, and its radius, a good estimate of error.

Billing to client is by subscription, or against mobile telephone card.

Radiotelephony signs like carriers. Radiolocalización signs can be transmitted as radio-phone messages, so that between emitted radio-localization message from a mobile and message answer from a fixed station, don't have more retards between both that derived of fixed electronic circuits.

An advantage is a low installation cost. An inconvenience is that error can be very big, because won't be been able code messages of superior frequency to bandwidth.

Topographical use. It is the most direct application of inventive idea. A strongly directional antenna points a reflective surface, also directional, deviating emission outside of emitter antenna, being collected reflected wave by a concentric antenna to the first antenna. If a radiation is emitted like described in previous paragraphs, its reflected allows calculate distance, in an identical way. They are necessary only IE and N fields, formation of initial sign circuit, identifier circuit, data captator circuit and microprocessor for calculation and presentation of results.

### INDUSTRIAL APPLICATION.

Their best application is terrestrial radiolocalización: transport fleets administration, goods control, high security sealing. Particularly they can be added as a function to a mobile radio-telephone.

I claim for:

1. Radio-localization method of a mobile by obtaining distances to three radio-stations of known position characterized in an initial sign from mobile having the following fields: emission identification (IE), mobile identification (IT), initial counter (N), coordinate identificator (IC) and operation retards (IR),
this fields are emitted in a frequency FX,
in initial sign IC and IR are blank,
each fixed radio-station continually receives this sign, fills IC and IR, and re-emits in frequency <>FX
mobile, by comparing N of reflected sign with their counter value NN at reflected sign reception, subtracting retards of radio-station IR and retards of own mobile IRX, it obtains distance to repeater radio-station,
a estimation of mobile position is the circle of smaller radius tangent to the three circles defined by the repeater radio-stations and calculated distance to each radio-station,
IE is fix, excepted their first bit that identifies if sign is direct or repeated.

2. Radio-localization method of a mobile according claim 1, characterized in that three elipses of known focuses are obtained from three fixed radio-stations, being the mobile position the circle of smaller radius tangent to the three elipses, being obtained each ellipse according to following:
initial sign is emitted by a fixed radio-station, being IT its geographical position,
each initial sign is re-emitted by another fixed radio-station,
the mobile receives both signs, and calculates difference between semi-axes ellipse,
focuses are geographical position of both fixed radio-stations (IT and IC).

3. Radio-localization method of a mobile according claims 1 and 2, characterized by taking advantage of frequencies that are not used of a dedicated band, especially the radio-telephonic emissions, by the dynamic use of unoccupied frequencies; for that, mobile and fixed radio stations look over the frequency band to find free frequencies, to emit and receive so initial signs as reflected sign.

4. Radio-localization method of a mobile according claim 1 characterized in that standard radio-telephony signs are used as carriers.

5. Billing method of radio-localization services according claims 1, 3 and 4, characterized in that IT field is used to generate an account note in a centralized system.

6. Billing method of radio-localization services according claims 1 to 4, characterized by a note against the mobile card based in higher NN field.

7. Radio-localization system of a mobile by obtaining distances to three radio-stations of known position characterized in having the following devices, that are activated consecutively:
in mobile, initial sign emitter, formation circuit of initial sign with IE, IT, N, IC and IR fields; IC and IR are blank; first bit of IE 0/1;
in each fixed radio-station, initial sign receiver; repeater circuit which fills IC and IR fields with geographical position and operation retards of radio-station, changing first bit of IE to 1/0; billing of service using IT field; and emitter;
in mobile, reflected sign receiver; data captator circuit, with first identificator bit 1/0; microprocessor to process and show data, in a screen in the mobile, or in a preprogramed destination, via a message.

8. Radio-localization system of a mobile according claim 7 characterized in that billing service is in mobile, being based in higher NN field, via a note against the mobile card.

9. Radio-localization system of a mobile according claim 7, by obtaining three elipses of known focuses from three fixed radio-stations, being the mobile position the circle of smaller radius tangent to the three elipses, being characterized in that:
emitters of initial sign, formation of initial sign circuit are in fixed radio-stations,
billing service is in mobile,
reflected sign receiver has only len(IE)−1 last identificator bits, data captator circuit include bit's captator circuits to get IT.

10. Radio-localization system of a mobile according claims 7 to 9 characterized in that formation of initial sign circuit is a sequencer having constant bits of IE, IT, IC and IR fields; a counter with bit of N field, a clock of pulses; individual sequencer by each bit of sign; having each individual sequencer a flip-flop to transmit a sequence sign by pulses from clock.

11. Radio-localization system of a mobile according claims 7 to 9 characterized in that repeater circuit have the following devices:
clock of pulses,
identification circuits for bits of IE field, being each identificator a comparator between received bit and a comparison bit, and a flip-flop acting of sequencer if identification is positive,
in parallel to first identificator bit has a circuit that changes the first bit of IE,
following last identification circuit a counter, with a paraller comparator bit to bit of counter, permitting both devices that IC and IR transit without changes,
sequencers to insert IC and IR fields.

12. Radio-localization system of a mobile according claims 7 to 9 characterized in that data captator circuit have the following devices:
clock of pulses,
identification circuits for bits of IE and IT fields, being the first identifier bit opposite to initial sign of IE,
bit's captator circuits to get N, IT and IR fields, each individual captator having two flip-flops, one to contain value of each bit and the other as sequencer,
parallel flip-flop with counter bits, to contain value of NN,
connections between flip-flops containing data and microprocessor.

13. Radio-localization system of a mobile according claims 7 to 9 characterized in that the emitter and receiver circuits have automatic tuners to search free frequencies, and the emitters have oscillators synchronized with tuners,
tuner's exit is entrance to a rectifier,
rectifier's exit is entrance to a comparator with a threshold tension, if tension to compare is upper threshold tension, an pulse is generated, doing that tuner and/or oscillator change frequency,
counter controlled by clock of pulses to limit time on a frequency, by a pulse on tuner and/or oscillator doing that they change frequency.

14. Radio-localization system of a mobile according claims 7 to 13 characterized in that previous circuits are added as a function to a mobile radio-telephone.

15. Use distance measure system to obtain topographical distances characterized in having a formation of intitial sign circuit connected to a strongly directional antenna pointing to a reflective surface also directional that diverts emission outside of emitter antenna, being collected reflected wave by a concentric antenna to first antenna, being connected concentric antenna to a data captator circuit, and this captator circuit being connected to a microprocessor for calculation and presentation of results.
